(19) United States
(12) Patent Application Publication
(10) Pub. No.: US 2004/0101155 A1
(43) Pub. Date: May 27, 2004

(54) Fixing disk for connecting voice coil with drum paper and retaining them in a speaker

(76) Inventor: Yen-Chen Chan, Hsin Chuang City (TW)

Correspondence Address: Jason Z. Lin, Supreme Patent Services, Post Office Box 2339, Saratoga, CA, 95070-0339, US

(21) Appl. No.: 10/303,094

(22) Filed: Nov. 22, 2002

(51) Int. Cl. H04R 1/00; H04R 9/06; H04R 11/02

(52) U.S. Cl. 381/407

(57) ABSTRACT

In a fixing disk for connecting voice coil with drum paper and retaining them in a speaker, a circular fixed lid for jointing with an upper edge of a voice coil is laid in center of the fixing disk, and the circumferential edge of the fixed lid is connected with a plurality of connection ribs. The other end of each connection rib is then connected with an annular fixed piece, which is inclined in a same oblique angle with the drum paper such that it can be thoroughly fitted on the drum paper when the fixed lid covers the voice coil. By so doing, the fixing disk of this invention can fasten the voice coil and the drum paper together to raise the tone quality of the synchronous vertical vibration of the drum paper and the voice coil when the voice coil is outputting the audio power.

### FIELD OF THE INVENTION

The present invention relates to a structure of a speaker, and more particularly to a fixing disk of a speaker for connecting with both the voice coil and the drum paper to synchronize their vibration frequencies without inclination.

### BACKGROUND OF THE INVENTION

With regard to a common speaker, a voice coil is usually enclosed and fixed linearly in a central opening of a drum paper. In such a combination manner, the voice coil will be inevitably ruptured or detached from the drum paper due to vibration in the long run. Furthermore, because a soft ring is adopted for connecting the drum paper to the speaker main-body, hence, the voice coil together with the drum paper could be horizontally displaced in addition to the vertical displacement made when both of them are interactively vibrated up and down, so that the tone quality of the speaker would be considerably degraded.

### SUMMARY OF THE INVENTION

In view of the defects mentioned, this invention is intended to disclose a fixing disk for connecting with both the voice coil and the drum paper to synchronize their vibration frequencies without inclination. A circular fixed lid for jointing with an upper edge of the voice coil is laid in center of the fixing disk, and the circumferential edge of the fixed lid is connected with a plurality of connection ribs. The other end of each connection rib is then connected with an annular fixed piece, which is inclined in a same oblique angle with the drum paper such that it can be thoroughly fitted on the drum paper when the fixed lid covers the voice coil. By so doing, the fixing disk of this invention can fasten the voice coil and the drum paper together to raise the tone quality of the synchronous vertical vibration of the drum paper and the voice coil when the voice coil is outputting the audio power.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows an embodiment of this invention in three dimensions;

FIG. 2 shows a three-dimensional exploded view of this invention;

FIG. 3 shows a cutaway sectional view of this invention;

FIG. 4 shows an embodiment of a fixing disk (I) of this invention; and

FIG. 5 shows an embodiment of a fixing disk (II) of this invention.

### DETAILED DESCRIPTION OF THE INVENTION

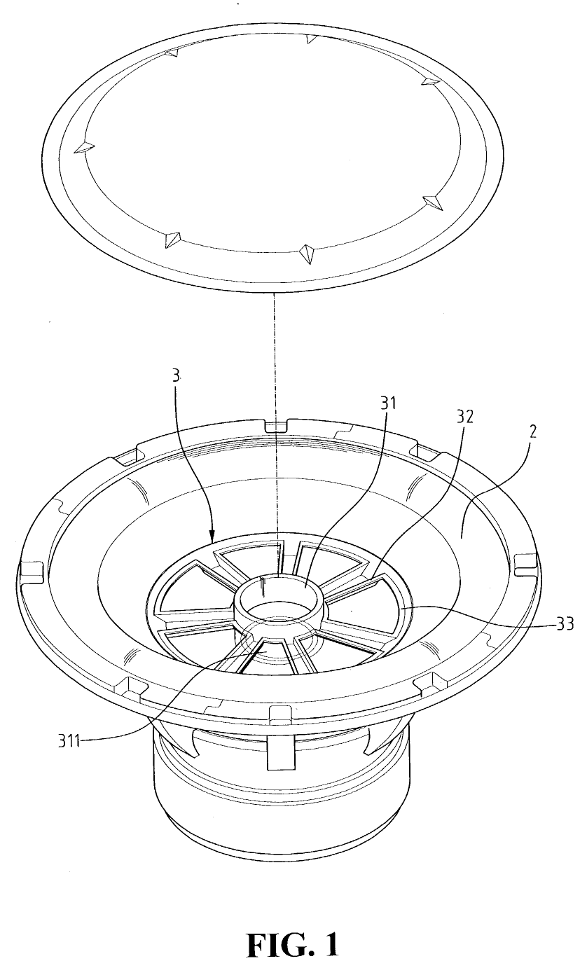

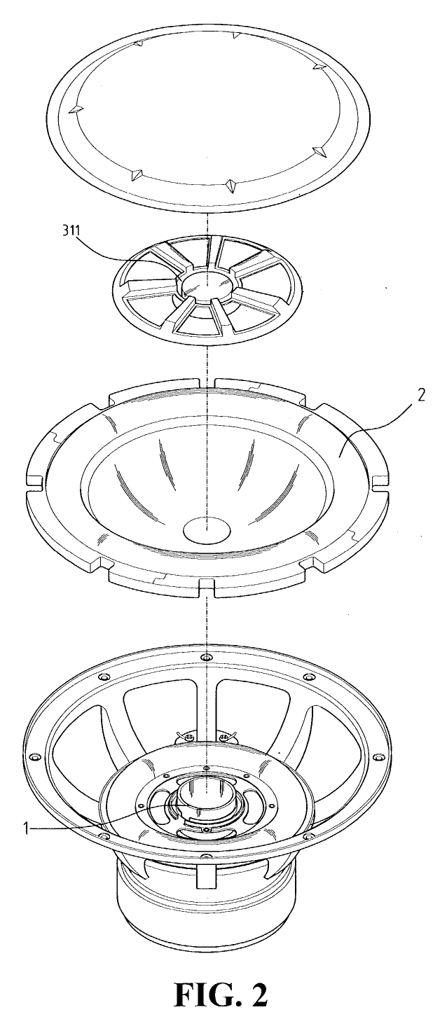

A fixing disk of this invention to be applied in a speaker is illustrated in FIGS. 1, 2, and 3, showing an embodiment, an exploded view, and a sectional view thereof. As indicated, a fixing disk (3) for connecting a voice coil (1) with a drum paper (2) and retaining them stably in a speaker is provided with a fixed lid (31) in form of a circular disk positioned in the center of the fixing disk, in which an annular gap (311) is formed peripherally around the fixed lid (31). By means of the annular gap (311), the fixed lid (31) can be settled on an upper edge of the voice coil (1). The circumferential edge of the fixed lid (31) is connected with a plurality of connection ribs (32), which has another end coupled with an annular fixed piece (33). The annular fixed piece (33) is inclined in an oblique angle same as that of the drum paper (2), such that the fixed piece (33) will be thoroughly attached onto the drum paper (2), and the fixing disk, the voice coil, and the drum paper could be jointed together (with a binder) after the fixed lid (31) of the fixing disk (3) is covered on the voice coil (1). Therefore, when the voice coil (1) is outputting audio power, the drum paper (2) will follow the voice coil (1) to vibrate up and down stably without causing any vibration imbalance of the drum paper (2) right or left to hence heighten the tone quality.

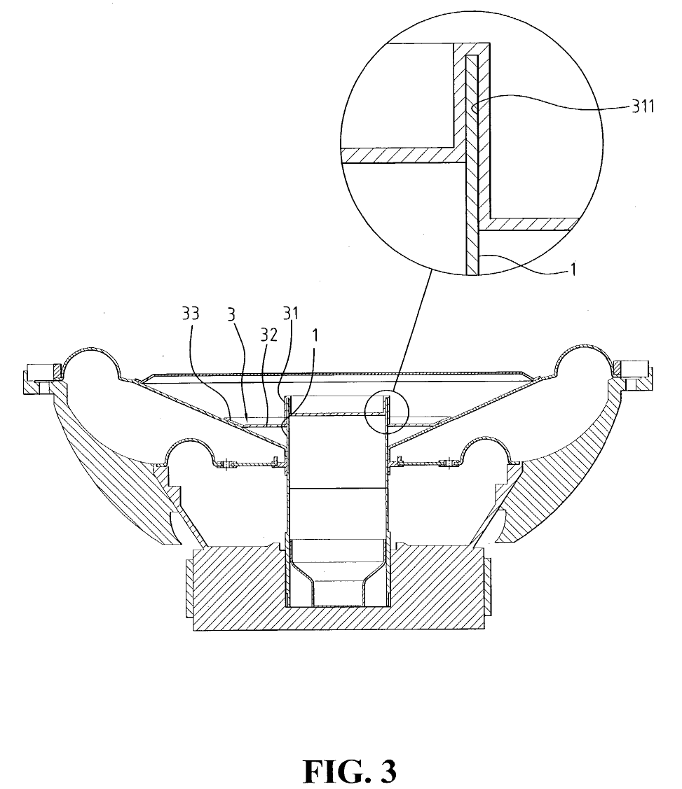

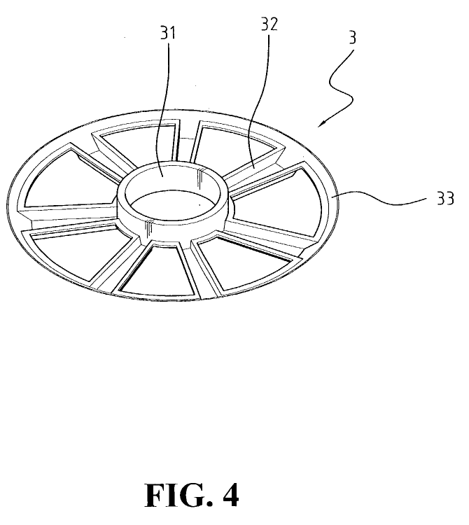

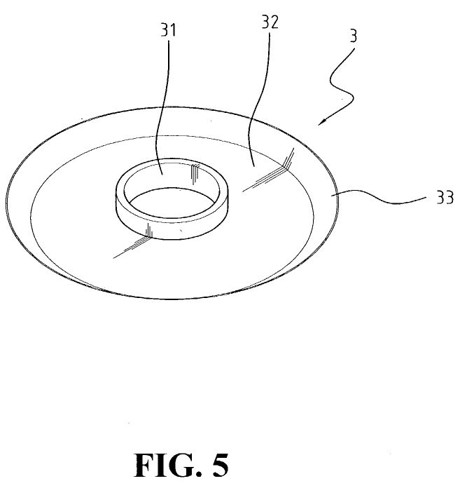

FIGS. 4 and 5 show embodiments (I) and (II) respectively of fixing disk of this invention. In the embodiments, a fixing disk (3) is composed of a fixed lid (31), a plurality of connection ribs (32), and a fixed piece (33), in which the fixed piece (33) is substantially an annular plate inclined in an oblique angle same as a drum paper (2) (also referring to FIG. 3) such that the later could be smoothly jointed and vibrates stably. Moreover, the fixed lid (31) in center of the fixing disk (3) could be formed as a donut, and the connection ribs (32) connected peripherally with the fixed lid (31) could be configured in a single tablet structure.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A fixing disk for connecting voice coil with drum paper and retaining them in a speaker, said fixing disk having a fixed lid in center; the peripheral edge of said fixed lid being connected with a plurality of connection ribs; the outer ends of said connection ribs are connected with an annular fixed piece, in which the annular fixed piece is inclined in an oblique angle same as that of a drum paper.

2. The fixing disk according to claim 1, in which said connection rib is configured in form of a strip.

3. The fixing disk according to claim 1, in which said connection rib is configured in form of an annular plate.

4. The fixing disk according to claim 1, in which said fixed lid is made in form of a donut.

5. The fixing disk according to claim 1, in which said fixed lid is configured in a disk.

6. The fixing disk according to claim 1, in which an annual gap is formed peripherally around said fixed lid.
